(19) United States
(12) Patent Application Publication
(10) Pub. No.: US 2026/0142473 A1
(43) Pub. Date: May 21, 2026

(54) CHARGING AND DISCHARGING CIRCUIT

(71) Applicant: Delta Electronics (Shanghai) Co., Ltd., Shanghai (CN)

(72) Inventors: Huiming Dai, Shanghai (CN); Haixin Wu, Shanghai (CN); Yueyong Meng, Shanghai (CN)

(21) Appl. No.: 19/365,868

(22) Filed: Oct. 22, 2025

(30) Foreign Application Priority Data
Nov. 19, 2024 (CN) 202411659727.0

(51) Int. Cl. H02J 7/02; H02J 7/00; H02M 1/44

(52) U.S. Cl. CPC H02J 7/02; H02J 7/855; H02J 7/865; H02M 1/44; H02J 2105/37; H02J 2207/20

(57) ABSTRACT

A charging and discharging circuit is provided. By controlling the operations of the switches in a first bridge arm, a second bridge arm, a third bridge arm, a fourth bridge arm and a fifth bridge arm of the power conversion module, controller selectively enables first AC power and/or the first DC power to simultaneously transmit bidirectional energy through the EMI module and the power conversion module. The charging and discharging circuit of the present disclosure can achieve both the charging function and the discharging function by using a single circuit. In addition, the charging and discharging circuit of the present disclosure can provide uninterrupted power in different scenarios to meet multi-purpose needs.

### CROSS-REFERENCE TO RELATED APPLICATION

This application claims priority to China Patent Application No. 202411659727.0 filed on Nov. 19, 2024, the entire content of which is incorporated herein by reference for all purposes.

### FIELD OF THE INVENTION

The present disclosure relates to a charging and discharging circuit, and more particularly to a charging and discharging circuit for an on-board charge module (OBCM).

### BACKGROUND OF THE INVENTION

As new energy vehicles become increasingly popular, the functional requirements for new energy vehicles are increasing. Conventionally, most of the charging and discharging circuits in the on-board chargers of new energy vehicles are operated in a single operation mode. That is, they can only be operated in either a charging mode or a discharging mode, and can't be operated in both of the charging mode and the discharging mode. Besides, in order to meet the in-vehicle charging and discharging requirements, the large new energy vehicle need to install an on-board charger and an on-board inverter which causes a larger size and a high construction cost. Furthermore, when energy is converted between the input port and the output port of the new energy vehicle, the energy is transferred through the AC/DC conversion module and the DC/DC conversion module of the on-board charger and the AC/DC conversion module and the DC/DC conversion module of the on-board inverter. Consequently, the power conversion loss increases, the conversion efficiency is low, and the energy-saving effect is unsatisfied.

Therefore, it is important to provide an improved charging and discharging circuit in order to overcome the drawbacks of the conventional technologies.

### SUMMARY OF THE INVENTION

The present disclosure provides a charging and discharging circuit. By controlling the operations of the switches in a first bridge arm, a second bridge arm, a third bridge arm, a fourth bridge arm and a fifth bridge arm of the power conversion module, the controller selectively enables a first AC power and/or a first DC power to transfer through an EMI module and the power conversion module in a manner of simultaneous bidirectional energy transmission. The charging and discharging circuit of the present disclosure can achieve both the charging function and the discharging function by using a single circuit. In addition, the charging and discharging circuit of the present disclosure can provide uninterrupted power in different scenarios to meet multi-purpose needs. Furthermore, by sharing a DC bus, the power conversion module can perform the AC/DC conversion and the DC/AC conversion, simultaneously. Since the DC/DC conversion is omitted, the conversion efficiency is enhanced. In other words, the charging and discharging circuit of the present disclosure has many advantages such as small volume, low construction cost, reduced power conversion loss and enhanced energy-saving effect.

In accordance with an aspect of the present disclosure, a charging and discharging circuit is provided. The charging and discharging circuit includes a first AC port (e.g., a charging and discharging port), a second AC port (e.g., a discharging port), a DC charging port, an electromagnetic interference (EMI) module, a power conversion module and a controller. The charging and discharging circuit selectively receives or provides a first AC power through the first AC port, selectively provides a second AC power through the second AC port, or selectively receives or provides a first DC power through the DC charging port. A first port of the EMI module is connected with the first AC port. A second port of the EMI module is connected with the second AC port. A third port of the EMI module includes a first terminal, a second terminal, a third terminal and a fourth terminal. The power conversion module is connected between the third port of the EMI module and the DC charging port. The power conversion module includes a first bridge arm, a second bridge arm, a third bridge arm, a fourth bridge arm and a fifth bridge arm. The first bridge arm includes two first switches connected in series. The second bridge arm includes two second switches connected in series. The third bridge arm includes two third switches connected in series. The fourth bridge arm includes two fourth switches connected in series. The fifth bridge arm includes two fifth switches connected in series. A first node between the two first switches is connected with the first terminal. A second node between the two second switches is connected with the first terminal. A third node between the two third switches is selectively connected with the first terminal or the second terminal according to an operation mode. A fourth node between the two fourth switches is connected with the fourth terminal. A fifth node between the two fifth switches is connected with the third terminal. The controller is configured to control operations of the first switches in the first bridge arm, the second switches in the second bridge arm, the third switches in the third bridge arm, the fourth switches in the fourth bridge arm and the fifth switches in the fifth bridge arm. Consequently, the controller selectively enables the first AC power and/or the first DC power to transfer through the EMI module and the power conversion module in a manner of simultaneous bidirectional energy transmission.

In accordance with another aspect of the present disclosure, a charging and discharging circuit is provided. The charging and discharging circuit includes a first AC port (e.g., a charging and discharging port), a second AC port (e.g., a discharging port), a DC charging port, an electromagnetic interference (EMI) module, a power conversion module and a controller. The charging and discharging circuit selectively receives or provides a first AC power through the first AC port, selectively provides a second AC power through the second AC port, or selectively receives or provides a first DC power through the DC charging port. The EMI module includes a first common mode inductor. The first common mode inductor includes a first winding, a second winding, a third winding, a fourth winding and a first magnetic core. The first winding, the second winding, the third winding and the fourth winding are wound around the first magnetic core. The first winding and the fourth winding are magnetically coupled with each other, and the second winding and the third winding are magnetically coupled with each other. A first terminal of the first winding and a first terminal of the fourth winding are connected with the first AC port. A first terminal of the second winding and a first terminal of the third winding are connected with the second AC port. The power conversion module is connected between the EMI module and the DC charging port. The controller is configured to control operations of switches in the power conversion module. Consequently, the controller selectively enables the first AC power and/or the first DC power to transfer through the EMI module and the power conversion module in a manner of simultaneous bidirectional energy transmission.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the circuitry topology of a charging and discharging circuit according to an embodiment of the present disclosure;

FIG. 2A is a schematic circuit diagram illustrating the operations of the charging and discharging circuit of FIG. 1 in a first operation mode;

FIG. 2B is a schematic timing waveform diagram illustrating the driving signals provided to the switches of the charging and discharging circuit of FIG. 1 in the first operation mode;

FIG. 3A is a schematic circuit diagram illustrating the operations of the charging and discharging circuit of FIG. 1 in a second operation mode;

FIG. 3B is a schematic timing waveform diagram illustrating the driving signals provided to the switches of the charging and discharging circuit of FIG. 1 in the second operation mode;

FIG. 4A is a schematic circuit diagram illustrating the operations of the charging and discharging circuit of FIG. 1 in a third operation mode;

FIG. 4B is a schematic timing waveform diagram illustrating the driving signals provided to the switches of the charging and discharging circuit of FIG. 1 in the third operation mode;

FIG. 5A is a schematic circuit diagram illustrating the operations of the charging and discharging circuit of FIG. 1 in a fourth operation mode;

FIG. 5B is a schematic timing waveform diagram illustrating the driving signals provided to the switches of the charging and discharging circuit of FIG. 1 in the fourth operation mode;

FIG. 6A is a schematic circuit diagram illustrating the operations of the charging and discharging circuit of FIG. 1 in a fifth operation mode;

FIG. 6B is a schematic timing waveform diagram illustrating the driving signals provided to the switches of the charging and discharging circuit of FIG. 1 in the fifth operation mode;

FIG. 7A is a schematic circuit diagram illustrating the operations of the charging and discharging circuit of FIG. 1 in a sixth operation mode;

FIG. 7B is a schematic timing waveform diagram illustrating the driving signals provided to the switches of the charging and discharging circuit of FIG. 1 in the sixth operation mode; and

FIG. 8 is a schematic perspective view illustrating the structure of a first common mode inductor of the EMI module in the charging and discharging circuit of FIG. 1.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Although the wide numerical ranges and parameters of the present disclosure are approximations, numerical values are set forth in the specific examples as precisely as possible. In addition, although the “first”, “second”, “third” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

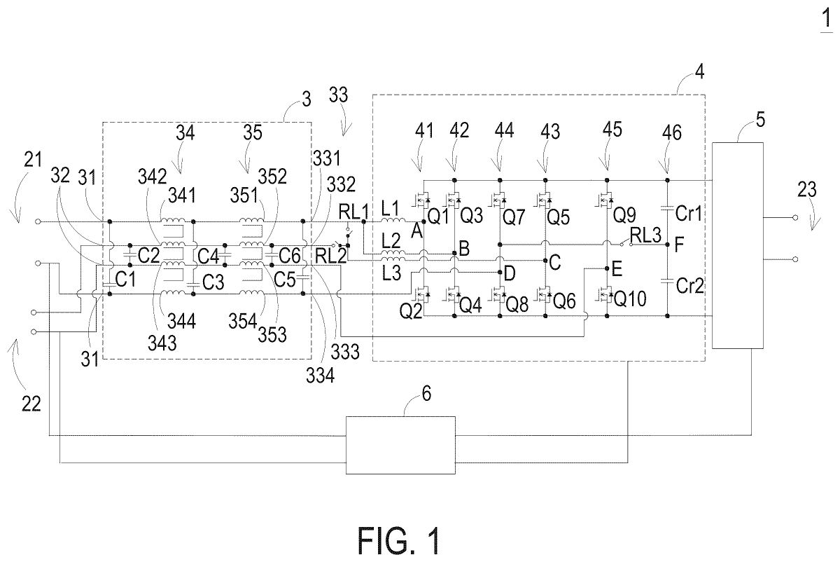

FIG. 1 is a schematic circuit diagram illustrating the circuitry topology of a charging and discharging circuit according to an embodiment of the present disclosure. The charging and discharging circuit 1 is connected with a charging gun (not shown), a vehicular internal receiving port (not shown) and a high-voltage battery (not shown). The charging and discharging circuit 1 can selectively receive a first AC power from the charging gun or provide the first AC power to the charging gun. The charging and discharging circuit 1 can selectively provide a second AC power to the vehicular internal receiving port. The charging and discharging circuit 1 can selectively receive a third AC power from the high-voltage battery or provide the third AC power to the high-voltage battery. For example, the charging and discharging circuit 1 is on-board charge module (OBCM).

In an embodiment, the charging and discharging circuit 1 includes a first AC port 21, a second AC port 22, a DC charging port 23, an electromagnetic interference (EMI) module 3, a power conversion module 4 and a controller 6. The charging and discharging circuit 1 is connected with the charging gun through the first AC port 21. In addition, the charging and discharging circuit 1 receives/provides the first AC power from/to the charging gun through the first AC port 21. The charging and discharging circuit 1 is connected with the vehicular internal receiving port through the second AC port 22. In addition, the charging and discharging circuit 1 receives/provides the second AC power from/to the vehicular internal receiving port through the second AC port 22. The charging and discharging circuit 1 is connected with the high-voltage battery through the DC charging port 23. In addition, the charging and discharging circuit 1 receives/provides the third AC power from/to the high-voltage battery through the DC charging port 23. The charging and discharging circuit 1 can be selectively operated in one of various operation modes. The operations of the charging and discharging circuit 1 will be described in more detail later.

The EMI module 3 includes a first port 31, a second port 32 and a third port 33. The first port 31 of the EMI module 3 is connected with the first AC port 21 and includes two terminals. The second port 32 of the EMI module 3 is connected with the second AC port 22 and includes two terminals. The third port 33 of the EMI module 3 includes a first terminal 331, a second terminal 332, a third terminal 333 and a fourth terminal 334.

The power conversion module 4 is connected between the third port 33 of the EMI module 3 and the DC charging port 23. The power conversion module 4 includes a first bridge arm 41, a second bridge arm 42, a third bridge arm 43, a fourth bridge arm 44 and a fifth bridge arm 45. The charging and discharging circuit 1 further includes a first inductor L1, a second inductor L2 and a third inductor L3.

The first bridge arm 41 includes two first switches, i.e., a first upper switch Q1 and a first lower switch Q2. The first upper switch Q1 and the first lower switch Q2 are connected in series. The connection point between the first upper switch Q1 and the first lower switch Q2 is a first node A. The first node A is connected with the first terminal 331 of the third port 33 of the EMI module 3 through the first inductor L1.

The second bridge arm 42 includes two second switches, i.e., a second upper switch Q3 and a second lower switch Q4. The second upper switch Q3 and the second lower switch Q4 are connected in series. The connection point between the second upper switch Q3 and the second lower switch Q4 is a second node B. The second node B is connected with the first terminal 331 of the third port 33 of the EMI module 3 through the second inductor L2.

The third bridge arm 43 includes two third switches, i.e., the third upper switch Q5 and the third lower switch Q6. The third upper switch Q5 and the third lower switch Q6 are connected in series. The connection point between the third upper switch Q5 and the third lower switch Q6 is a third node C. The third node C is selectively connected with the first terminal 331 or the second terminal 332 of the third port 33 of the EMI module 3 through the third inductor L3 according to different operation modes.

The fourth bridge arm 44 includes two fourth switches, i.e., a fourth upper switch Q7 and a fourth lower switch Q8. The fourth upper switch Q7 and the fourth lower switch Q8 are connected in series. The connection point between the fourth upper switch Q7 and the fourth lower switch Q8 is a fourth node D. The fourth node D is connected with the fourth terminal 334 of the third port 33 of the EMI module 3.

The fifth bridge arm 45 includes two fifth switches, i.e., a fifth upper switch Q9 and a fifth lower switch Q10. The fifth upper switch Q9 and the fifth lower switch Q10 are connected with each other in series. The connection point between the fifth upper switch Q9 and the fifth lower switch Q10 is a fifth node E. The fifth node E is connected with the third terminal 333 of the third port 33 of the EMI module 3

In an embodiment, the charging and discharging circuit 1 further includes a DC bus capacitor bridge arm 46. The DC bus capacitor bridge arm 46 includes two conversion capacitors Cr1 and Cr2. The two conversion capacitors Cr1 and Cr2 are connected in series. The connection point between the two conversion capacitors Cr1 and Cr2 is a sixth node F. The sixth node F is connected with the fourth node D of the fourth bridge arm 44.

In this embodiment, an AC/DC converter and DC/AC converter, e.g., a PFC converter and DC/AC inverter, are defined by the first bridge arm 41, the second bridge arm 42, the third bridge arm 43, the fourth bridge arm 44 and the fifth bridge arm 45 of the power conversion module 4 collaboratively. The first input port of the AC/DC converter and DC/AC converter is connected with the charging gun to perform bidirectional energy transmission. That is, both of the charging function and the discharging function can be simultaneously achieved. The second input port of the AC/DC converter and DC/AC converter is connected with the vehicular internal receiving port.

In an embodiment, the switches in the first bridge arm 41, the second bridge arm 42, the third bridge arm 43, the fourth bridge arm 44 and the fifth bridge arm 45 for example are Si MOSFETs, SiC MOSFETs, IGBTs or GaNs. In some embodiments, the AC/DC converter in the AC/DC converter and DC/AC converter includes an interleaved multi-channel totem pole PFC topology, and the DC/AC converter in the AC/DC converter and DC/AC converter also includes an interleaved multi-channel totem pole PFC topology.

In an embodiment, the charging and discharging circuit 1 further includes a first mechanical switch RL1, a second mechanical switch RL2 and a third mechanical switch RL3. The first terminal of the first mechanical switch RL1 is connected with the first terminal 331 of the third port 33 of the EMI module 3. The first terminal of the second mechanical switch RL2 is connected with the second terminal 332 of the third port 33 of the EMI module 3. The second terminal of the first mechanical switch RL1, the second terminal of the second mechanical switch RL2 and the third node C of the third bridge arm 43 are connected with each other. In other words, the third node C is connected with the first terminal 331 and the second terminal 332 of the third port 33 of the EMI module 3 through the first mechanical switch RL1 and the second mechanical switch RL2, respectively. The first terminal of the third mechanical switch RL3 is connected with the fourth node D of the fourth bridge arm 44 of the power conversion module 4. The second terminal of the third mechanical switch RL3 is connected with the sixth node F of the DC bus capacitor bridge arm 46 of the power conversion module 4. Due to the arrangement of the third mechanical switch RL3, the switching function between the totem pole topology (i.e., the first bridge arm 41, the second bridge arm 42 and the fourth bridge arm 44) and the half-bridge topology (i.e., the fourth bridge arm 44 and the DC bus capacitor bridge arm 46) can be achieved.

In an embodiment, the charging and discharging circuit 1 further includes a DC/DC conversion module 5. For example, the DC/DC conversion module 5 includes an LLC circuit topology, a CLLC circuit topology, a hard switch or a DAB circuit topology. In some other embodiments, the DC/DC conversion module 5 is an isolated converter. The primary side circuit of the isolated converter is a full-bridge circuit or a half-bridge circuit. The secondary circuit of the isolated converter is a full-bridge circuit, a half-bridge circuit or a center-tapped circuit. The DC/DC conversion module 5 is connected between the power conversion module 4 and the DC charging port 23 to perform the DC power conversion and is a bidirectional converter.

The controller 6 is connected with the first AC port 21, the second AC port 22, the DC charging port 23 and the power conversion module 4. The controller 6 controls the operations of the switches in the first bridge arm 41, the second bridge arm 42, the third bridge arm 43, the fourth bridge arm 44 and the fifth bridge arm 45 of the power conversion module 4. Consequently, the controller 6 selectively controls the first AC power and/or the first DC power to transferred through the EMI module 3 and the power conversion module 4 in the manner of simultaneous bidirectional energy transmission.

The corresponding switches of the charging and discharging circuit 1 are controlled by the controller 6 according to different operation modes.

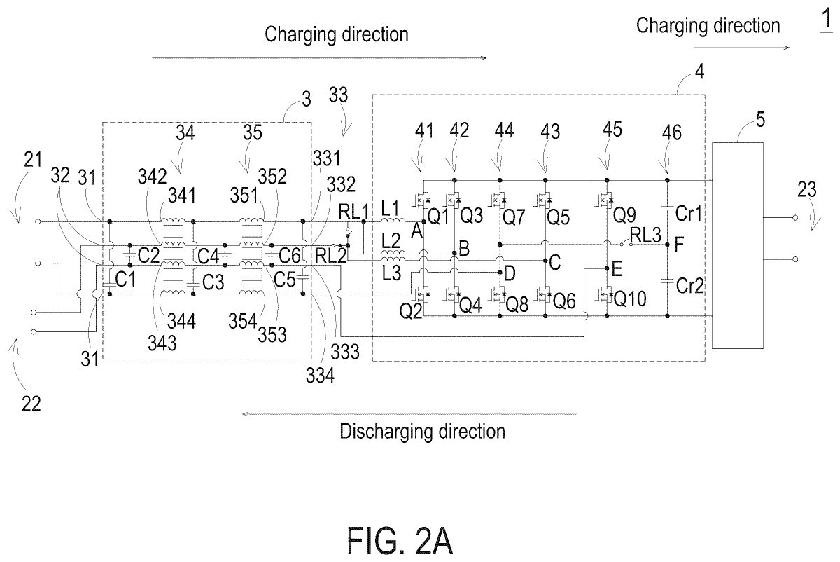

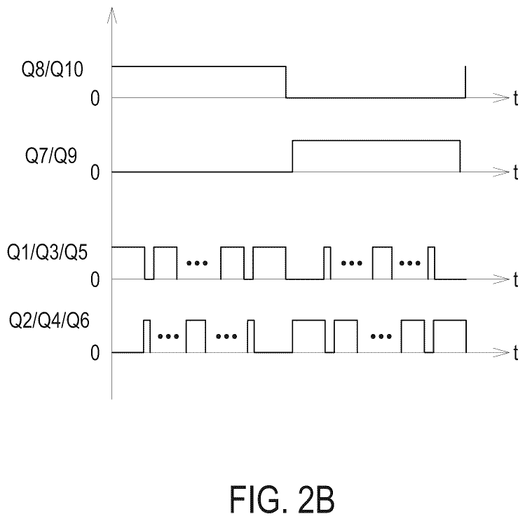

FIG. 2A is a schematic circuit diagram illustrating the operations of the charging and discharging circuit of FIG. 1 in a first operation mode. FIG. 2B is a schematic timing waveform diagram illustrating the driving signals provided to the switches of the charging and discharging circuit of FIG. 1 in the first operation mode.

Please refer to FIG. 2A. In the first operation mode, the controller 6 determines that the charging energy of the first AC power at the first AC port 21 is greater than or equal to the discharging energy of the second AC power at the second AC port 22. Under control of the controller 6, the second mechanical switch RL2 is turned on, and the first mechanical switch RL1 is turned off. Under this circumstance, the first bridge arm 41, the second bridge arm 42 and the fourth bridge arm 44 are collaboratively formed as an AC/DC converter. For example, the AC/DC converter is a two-way interleaved totem-pole PFC topology. The switches of the first bridge arm 41 and the second bridge arm 42 are used as high-frequency chopping switches, and the switches of the fourth bridge arm 44 are used as power frequency switches. Consequently, the first AC power from the first AC port 21 is converted into the first DC power by the power conversion module 4, and the first DC power is provided to the DC charging port 23. Simultaneously, the third bridge arm 43 and the fifth bridge arm 45 are collaboratively formed as a DC/AC converter. The switches of the third bridge arm 43 are used as high-frequency chopping switches, and the switches of the fifth bridge arm 45 are used as power frequency switches. Consequently, the first AC power from the first AC port 21 is converted into the second AC power by the power conversion module 4, and the second AC power is provided to the second AC port 22. The surplus charging energy of the first AC power from the first AC port 21 can be provided to charge the high voltage battery through the DC/DC conversion module 5.

Please refer to FIG. 2B. A first driving signal is provided to the first upper switch Q1 of the first bridge arm 41, the second upper switch Q3 of the second bridge arm 42 and the third upper switch Q5 of the third bridge arm 43. A second driving signal is provided to the first lower switch Q2 of the first bridge arm 41, the second lower switch Q4 of the second bridge arm 42 and the third lower switch Q6 of the third bridge arm 43. In addition, the first driving signal and the second driving signal are complementary. A third driving signal is provided to the fourth upper switch Q7 of the fourth bridge arm 44 and the fifth upper switch Q9 of the fifth bridge arm 45. A fourth driving signal is provided to the fourth lower switch Q8 of the fourth bridge arm 44 and the fifth lower switch Q10 of the fifth bridge arm 45. The third driving signal and the fourth driving signal are complementary.

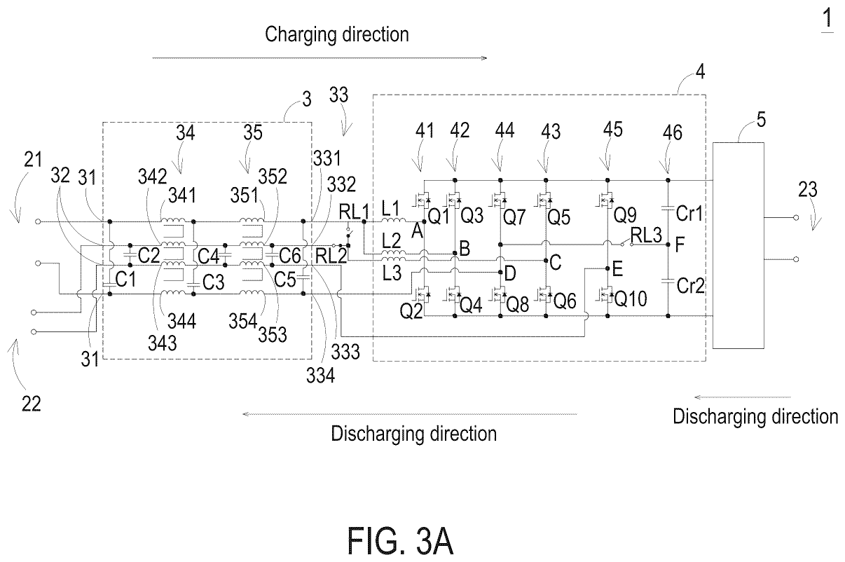

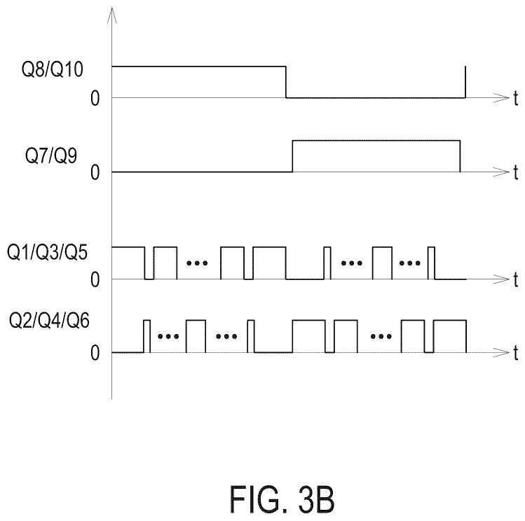

FIG. 3A is a schematic circuit diagram illustrating the operations of the charging and discharging circuit of FIG. 1 in a second operation mode. FIG. 3B is a schematic timing waveform diagram illustrating the driving signals provided to the switches of the charging and discharging circuit of FIG. 1 in the second operation mode.

Please refer to FIG. 3A. In the second operation mode, the controller 6 determines that the charging energy of the first AC power at the first AC port 21 is less than the discharging energy of the second AC power at the second AC port 22. Under control of the controller 6, the second mechanical switch RL2 is turned on, and the first mechanical switch RL1 is turned off. Under this circumstance, the first bridge arm 41, the second bridge arm 42 and the fourth bridge arm 44 are collaboratively formed as an AC/DC converter. For example, the AC/DC converter is a two-way interleaved totem-pole PFC topology. The switches of the first bridge arm 41 and the second bridge arm 42 are used as high-frequency chopping switches, and the switches of the fourth bridge arm 44 are used as power frequency switches. Consequently, the first AC power from the first AC port 21 is converted into a second DC power by the power conversion module 4. Simultaneously, the third bridge arm 43 and the fifth bridge arm 45 are collaboratively formed as a DC/AC converter. The switches of the third bridge arm 43 are used as high-frequency chopping switches, and the switches of the fifth bridge arm 45 are used as power frequency switches. Consequently, the first DC power from the DC charging port 23 and the second DC power are converted into the second AC power by the power conversion module 4, and the second AC power is provided to the second AC port 22. Since the insufficient charging energy of the first AC power of the first AC port 21 is supplemented by the first DC power from the DC charging port 23, the sufficient energy can be provided to the second AC port 22.

Please refer to FIG. 3B. A first driving signal is provided to the first upper switch Q1 of the first bridge arm 41, the second upper switch Q3 of the second bridge arm 42 and the third upper switch Q5 of the third bridge arm 43. A second driving signal is provided to the first lower switch Q2 of the first bridge arm 41, the second lower switch Q4 of the second bridge arm 42 and the third lower switch Q6 of the third bridge arm 43. In addition, the first driving signal and the second driving signal are complementary. A third driving signal is provided to the fourth upper switch Q7 of the fourth bridge arm 44 and the fifth upper switch Q9 of the fifth bridge arm 45. A fourth driving signal is provided to the fourth lower switch Q8 of the fourth bridge arm 44 and the fifth lower switch Q10 of the fifth bridge arm 45. The third driving signal and the fourth driving signal are complementary.

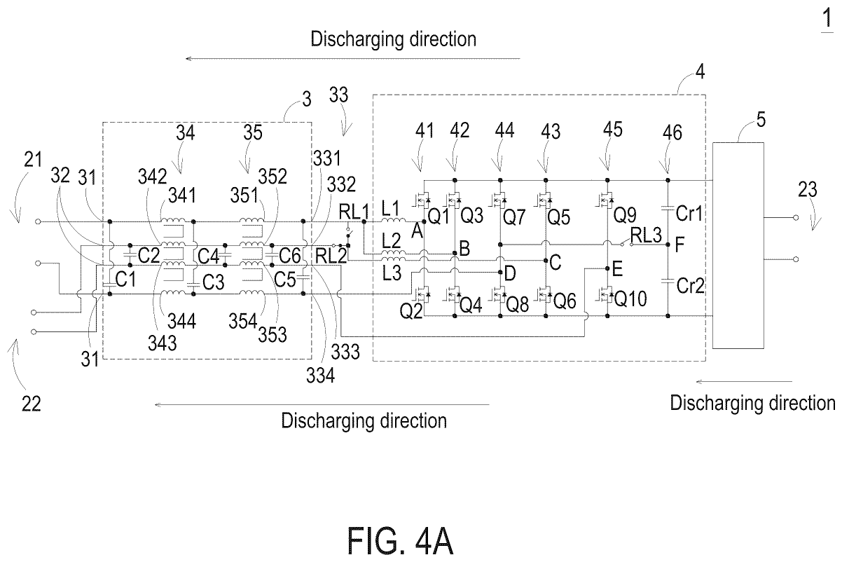

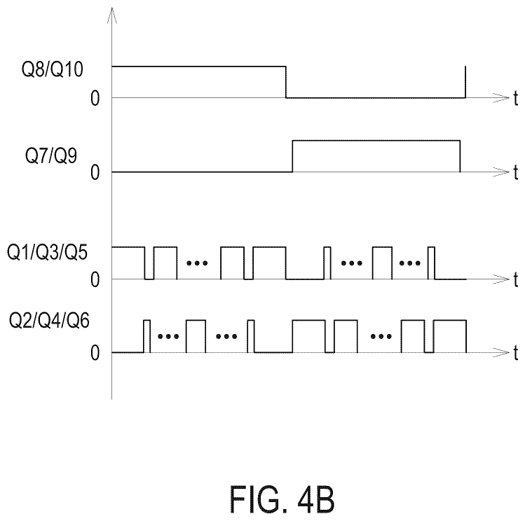

FIG. 4A is a schematic circuit diagram illustrating the operations of the charging and discharging circuit of FIG. 1 in a third operation mode. FIG. 4B is a schematic timing waveform diagram illustrating the driving signals provided to the switches of the charging and discharging circuit of FIG. 1 in the third operation mode.

Please refer to FIG. 4A. In the third operation mode, the controller 6 controls the first AC port 21 and the second AC port 22 to be in the discharging mode. Under control of the controller 6, the second mechanical switch RL2 is turned on, and the first mechanical switch RL1 is turned off. Under this circumstance, the first bridge arm 41, the second bridge arm 42 and the fourth bridge arm 44 are collaboratively formed as a DC/AC converter. For example, the DC/AC converter is a two-way interleaved totem-pole PFC topology. The switches of the first bridge arm 41 and the second bridge arm 42 are used as high-frequency chopping switches, and the switches of the fourth bridge arm 44 are used as power frequency switches. Consequently, the first DC power from the DC charging port 23 is converted into the first AC power by the power conversion module 4, and the first AC power is provided to the first AC port 21. Simultaneously, the third bridge arm 43 and the fifth bridge arm 45 are collaboratively formed as another DC/AC converter. The switches of the third bridge arm 43 are used as high-frequency chopping switches, and the switches of the fifth bridge arm 45 are used as power frequency switches. Consequently, the first DC power from the DC charging port 23 is converted into the second AC power by the power conversion module 4 simultaneously, and the second AC power is provided to the second AC port 22. In this way, the high voltage battery discharges electric energy to the first AC port 21 and the second AC port 22 through the DC/DC conversion module 5.

Please refer to FIG. 4B. A first driving signal is provided to the first upper switch Q1 of the first bridge arm 41, the second upper switch Q3 of the second bridge arm 42 and the third upper switch Q5 of the third bridge arm 43. A second driving signal is provided to the first lower switch Q2 of the first bridge arm 41, the second lower switch Q4 of the second bridge arm 42 and the third lower switch Q6 of the third bridge arm 43. In addition, the first driving signal and the second driving signal are complementary. A third driving signal is provided to the fourth upper switch Q7 of the fourth bridge arm 44 and the fifth upper switch Q9 of the fifth bridge arm 45. A fourth driving signal is provided to the fourth lower switch Q8 of the fourth bridge arm 44 and the fifth lower switch Q10 of the fifth bridge arm 45. The third driving signal and the fourth driving signal are complementary.

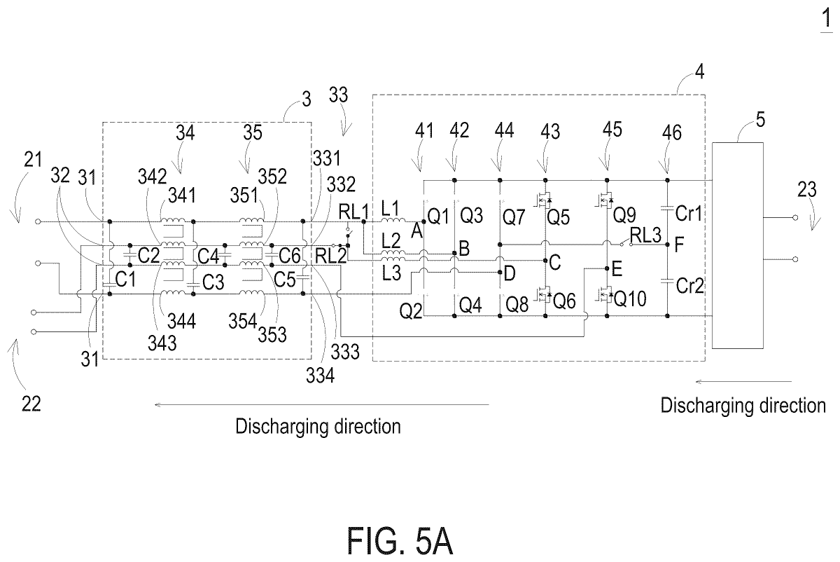

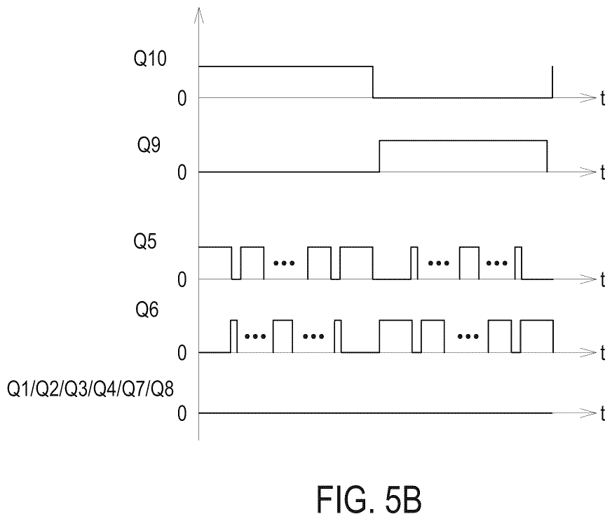

FIG. 5A is a schematic circuit diagram illustrating the operations of the charging and discharging circuit of FIG. 1 in a fourth operation mode. FIG. 5B is a schematic timing waveform diagram illustrating the driving signals provided to the switches of the charging and discharging circuit of FIG. 1 in the fourth operation mode.

Please refer to FIG. 5A. In the fourth operation mode, a vehicular internal receiving port (i.e., the first AC port 21) is in a standby state. Under control of the controller 6, the second mechanical switch RL2 is turned on, and the first mechanical switch RL1 is turned off. Under this circumstance, the third bridge arm 43 and the fifth bridge arm 45 are collaboratively formed as a DC/AC converter. The switches of the third bridge arm 43 are used as high-frequency chopping switches, and the switches of the fifth bridge arm 45 are used as power frequency switches. Consequently, the first DC power from the DC charging port 23 is converted into the second AC power by the power conversion module 4, and the second AC power is provided to the second AC port 22. In this way, the high voltage battery discharges electric energy to the second AC port 22 through the DC/DC conversion module 5.

Please refer to FIG. 5B. In this embodiment, the first upper switch Q1, the first lower switch Q2, the second upper switch Q3, the second lower switch Q4, the fourth upper switch Q7 and the fourth lower switch Q8 are turned off. The driving signal is provided to the third upper switch Q5 and the driving signal provided to third lower switch Q6 are complementary. The driving signal provided to the fifth upper switch Q9 and the driving signal provided to fifth lower switch Q10 are complementary to each other.

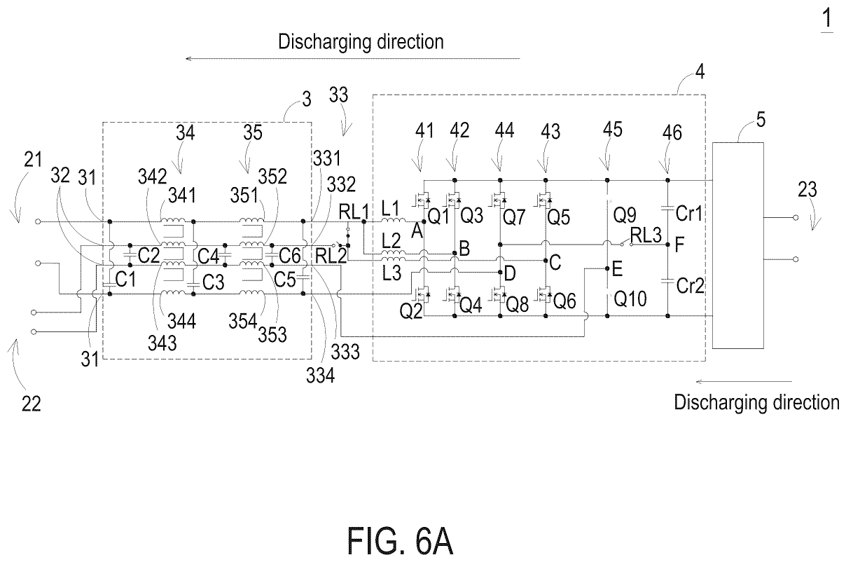

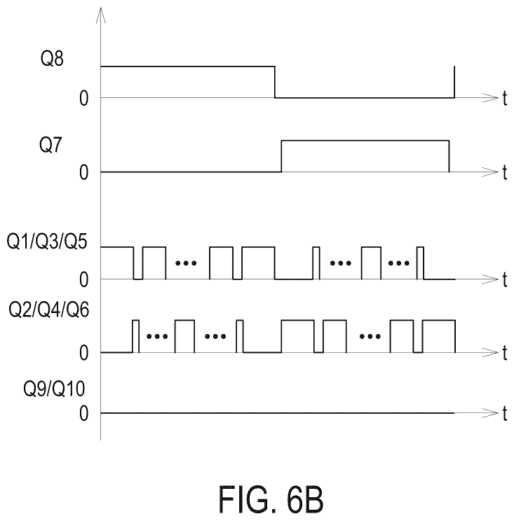

FIG. 6A is a schematic circuit diagram illustrating the operations of the charging and discharging circuit of FIG. 1 in a fifth operation mode. FIG. 6B is a schematic timing waveform diagram illustrating the driving signals provided to the switches of the charging and discharging circuit of FIG. 1 in the fifth operation mode.

Please refer to FIG. 6A. In the fifth operation mode, only the vehicular internal receiving port (i.e., the second AC port 22) is in the discharging mode. Under control of the controller 6, the first mechanical switch RL1 is turned on, and the second mechanical switch RL2 is turned off. Under this circumstance, the first bridge arm 41, the second bridge arm 42, the third bridge 43 and the fourth bridge arm 44 are collaboratively formed as a DC/AC converter. For example, the DC/AC converter has a three-way interleaved totem-pole PFC topology. The switches of the first bridge arm 41, the second bridge arm 42 and the third bridge 43 are used as high-frequency chopping switches, and the switches of the fourth bridge arm 44 are used as power frequency switches. Consequently, the first DC power from the DC charging port 23 is converted into the first AC power by the power conversion module 4, and the first DC power is provided to the first AC port 21. In this way, the high voltage battery discharges electric energy to the first AC port 21 through the DC/DC conversion module 5.

Please refer to FIG. 6B. In this embodiment, the fifth upper switch Q9 and the fifth lower switch Q10 of the fifth bridge arm 45 are turned off. A first driving signal is provided to the first upper switch Q1 of the first bridge arm 41, the second upper switch Q3 of the second bridge arm 42 and the third upper switch Q5 of the third bridge arm 43. A second driving signal is provided to the first lower switch Q2 of the first bridge arm 41, the second lower switch Q4 of the second bridge arm 42 and the third lower switch Q6 of the third bridge arm 43. In addition, the first driving signal and the second driving signal are complementary. A third driving signal is provided to the fourth upper switch Q7 of the fourth bridge arm 44. A fourth driving signal is provided to the fourth lower switch Q8 of the fourth bridge arm 44. The third driving signal and the fourth driving signal are complementary.

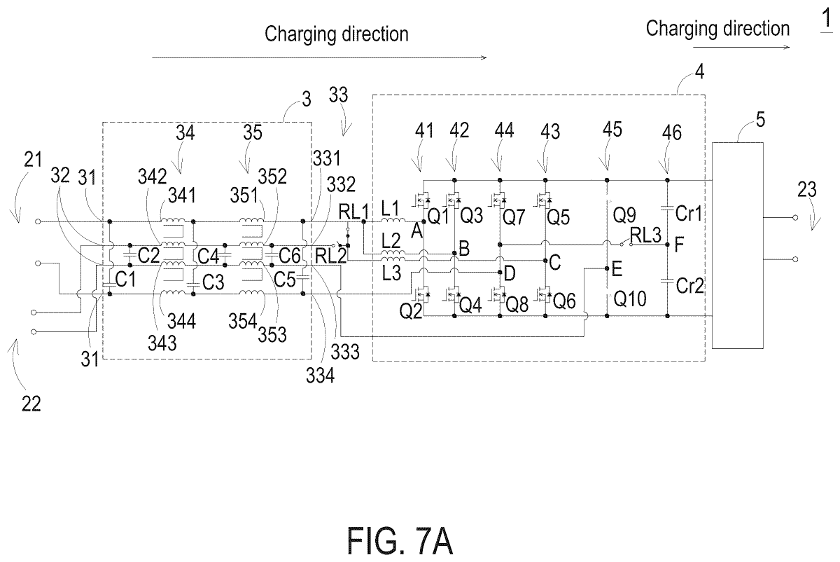

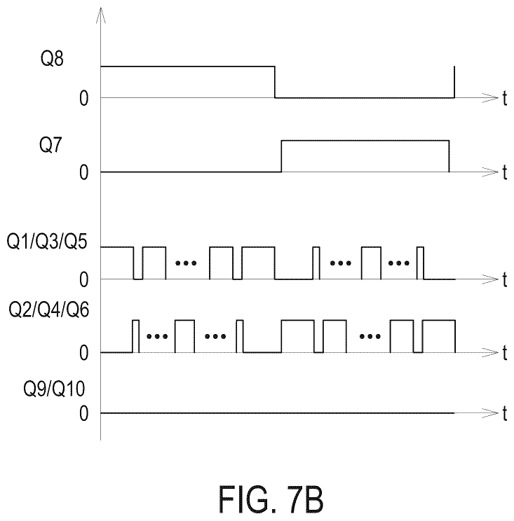

FIG. 7A is a schematic circuit diagram illustrating the operations of the charging and discharging circuit of FIG. 1 in a sixth operation mode. FIG. 7B is a schematic timing waveform diagram illustrating the driving signals provided to the switches of the charging and discharging circuit of FIG. 1 in the sixth operation mode.

Please refer to FIG. 7A. In the sixth operation mode, only the charging gun is in the charging mode. Under control of the controller 6, the first mechanical switch RL1 is turned on, and the second mechanical switch RL2 is turned off. Under this circumstance, the first bridge arm 41, the second bridge arm 42, the third bridge 43 and the fourth bridge arm 44 are collaboratively formed as an AC/DC converter. For example, the AC/DC converter is a three-way interleaved totem-pole PFC topology. The switches of the first bridge arm 41, the second bridge arm 42 and the third bridge 43 are used as high-frequency chopping switches, and the switches of the fourth bridge arm 44 are used as power frequency switches. Consequently, the first AC power from the first AC port 21 is converted into the first DC power by the power conversion module 4, and the first DC power is provided to the DC charging port 23. In this way, the charging gun provides electric energy to the high voltage battery.

Please refer to FIG. 7B. In this embodiment, the fifth upper switch Q9 and the fifth lower switch Q10 of the fifth bridge arm 45 are turned off. A first driving signal is provided to the first upper switch Q1 of the first bridge arm 41, the second upper switch Q3 of the second bridge arm 42 and the third upper switch Q5 of the third bridge arm 43. A second driving signal is provided to the first lower switch Q2 of the first bridge arm 41, the second lower switch Q4 of the second bridge arm 42 and the third lower switch Q6 of the third bridge arm 43. In addition, the first driving signal and the second driving signal are complementary. A third driving signal is provided to the fourth upper switch Q7 of the fourth bridge arm 44. A fourth driving signal is provided to the fourth lower switch Q8 of the fourth bridge arm 44. The third driving signal and the fourth driving signal are complementary.

As mentioned above, the controller 6 selectively enables the first AC power and/or the first DC power to transfer through the EMI module 3 and the power conversion module 4 in the manner of simultaneous bidirectional energy transmission, (e.g., the first operation mode or the second operation mode) by controlling the operations of the switches in the first bridge arm 41, the second bridge arm 42, the third bridge arm 43, the fourth bridge arm 44 and the fifth bridge arm 45 of the power conversion module 4. In comparison with the conventional charging and discharging circuit that can only work in a single mode or need to use at least two converters to perform the charging and discharging operation, the charging and discharging circuit 1 of the present disclosure can achieve both the charging function and the discharging function by using a single circuit. In addition, the charging and discharging circuit 1 of the present disclosure can provide uninterrupted power in different scenarios to meet multi-purpose needs. Furthermore, by sharing a DC bus, the power conversion module 4 can perform the AC/DC conversion and the DC/AC conversion, simultaneously. Since the DC/DC conversion is omitted, the conversion efficiency is enhanced. In other words, the charging and discharging circuit 1 of the present disclosure has many advantages such as small volume, low construction cost, reduced power conversion loss and enhanced energy-saving effect.

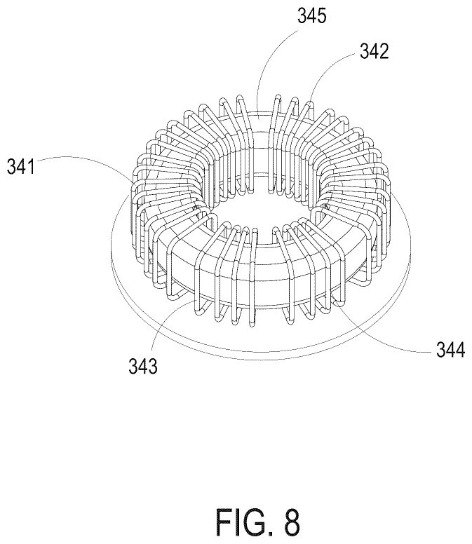

FIG. 8 is a schematic perspective view illustrating the structure of a first common mode inductor of the EMI module in the charging and discharging circuit of FIG. 1. In an embodiment, the EMI module 3 for example is a two-stage AC EMI filter. As shown in FIG. 1, the EMI module 3 includes a first common mode inductor 34, a second common mode inductor 35 and six capacitors. The first common mode inductor 34 includes a first winding 341, a second winding 342, a third winding 343, a fourth winding 344 and a first magnetic core 345. The first terminal of the first winding 341 is formed as one of the two terminals of the first port 31 of the EMI module 3. The first terminal of the second winding 342 is formed as one of the two terminals of the second port 32 of the EMI module 3. The first terminal of the third winding 343 is formed as the other of the two terminals of the second port 32 of the EMI module 3. The first terminal of the fourth winding 344 is formed as the other of the two terminals of the first port 31 of the EMI module 3. The two terminals of the first port 31 of the EMI module 3 are connected with the first AC port 21. The two terminals of the second port 32 of the EMI module 3 are connected with the second AC port 22. As shown in FIG. 8, the first winding 341, the second winding 342, the third winding 343 and the fourth winding 344 are wound around the first magnetic core 345. Furthermore, every two adjacent windings of the first winding 341, the second winding 342, the third winding 343 and the fourth winding 344 are magnetically coupled with each other. That is, the first winding 341 and the fourth winding 344 are magnetically coupled with each other, and the second winding 342 and the third winding 343 are magnetically coupled with each other. In some embodiments, the first magnetic core 345 is a ring-shaped magnetic core, a UU-type magnetic core, a UI-type magnetic core or an EQ-type magnetic core.

The structure of the second common mode inductor 35 is similar to the structure of the first common mode inductor 34 shown in FIG. 8. The second common mode inductor 35 includes a fifth winding 351, a sixth winding 352, a seventh winding 353, an eighth winding 354 and a second magnetic core (not shown). The first terminal of the fifth winding 351 is connected with the second terminal of the first winding 341. The second terminal of the fifth winding 351 is formed as the first terminal 331 of the third port 33 of the EMI module 3. The first terminal of the sixth winding 352 is connected with the second terminal of the second winding 342. The second terminal of the sixth winding 352 is formed as the second terminal 332 of the third port 33 of the EMI module 3. The first terminal of the seventh winding 353 is connected with the second terminal of the third winding 343. The second terminal of the seventh winding 353 is formed as the third terminal 333 of the third port 33 of the EMI module 3. The first terminal of the eighth winding 354 is connected with the second terminal of the fourth winding 344. The second terminal of the eighth winding 354 is formed as the fourth terminal 334 of the third port 33 of the EMI module 3. The fifth winding 351, the sixth winding 352, the seventh winding 353 and the eighth winding 354 are wound around the second magnetic core. Furthermore, every two adjacent windings of the fifth winding 351, the sixth winding 352, the seventh winding 353 and the eighth winding 354 are magnetically coupled with each other. That is, the fifth winding 351 and the eighth winding 354 are magnetically coupled with each other, and the sixth winding 352 and the seventh winding 353 are magnetically coupled with each other.

As mentioned above, each of the first common mode inductor 34 and the second common mode inductor 35 includes four windings that are wound on the same magnetic core. That is, the first common mode inductor 34 and the second common mode inductor 35 are integrated into the EMI module 3. It is noted that numerous modifications may be made while retaining the teachings of the present disclosure. For example, the EMI module 3 is not limited to the two-stage AC EMI filter. In some embodiments, the EMI module 3 is a three-stage AC EMI filter or a single-stage AC EMI filter. Since the first common mode inductor 34 and the second common mode inductor 35 of the EMI module 3 are configured in an integrated manner, the charging AC common mode inductor (e.g., the first winding and the fourth winding) and the discharging AC common mode inductor (e.g., the second winding and the third winding) share the same magnetic core. Consequently, the power density is increased, and the construction cost is further reduced.

In some embodiments, the EMI module 3 includes a single common mode inductor, e.g., the first common mode inductor 34 shown in FIG. 1. Under this circumstance, the first node A is directly connected with the second terminal of the first winding 341 through the first inductor L1, the second node B is connected with the second terminal of the first winding 341 through the second inductor L2, the third node C is connected with the second terminal of the second winding 342 and the second terminal of the first winding 341 through the third inductor L3, the fourth node D is connected with the second terminal of the fourth winding 344, and the fifth node E is connected with the second terminal of the third winding 343.

The six capacitors of the EMI module 3 include a first capacitor C1, a second capacitor C2, a third capacitor C3, a fourth capacitor C4, a fifth capacitor C5 and a sixth capacitor C6. The first capacitor C1 is connected between the first terminal of the first winding 341 and the first terminal of the fourth winding 344. The second capacitor C2 is connected between the first terminal of the second winding 342 and the first terminal of the third winding 343. The third capacitor C3 is connected between the second terminal of the first winding 341 and the second terminal of the fourth winding 344. The fourth capacitor C4 is connected between the second terminal of the second winding 342 and the second terminal of the third winding 343. The fifth capacitor C5 is connected between the second terminal of the fifth winding 351 and the second terminal of the eighth winding 354. The sixth capacitor C6 is connected between the second terminal of the sixth winding 352 and the second terminal of the seventh winding 353.

From the above descriptions, the present disclosure provides the charging and discharging circuit. the controller 6 selectively enables the first AC power and/or the first DC power to transfer through the EMI module 3 and the power conversion module 4 in the manner of simultaneous bidirectional energy transmission(e.g., the first operation mode or the second operation mode) by controlling the operations of the switches in the first bridge arm 41, the second bridge arm 42, the third bridge arm 43, the fourth bridge arm 44 and the fifth bridge arm 45 of the power conversion module 4. The charging and discharging circuit of the present disclosure can achieve both the charging function and the discharging function by using a single circuit. In addition, the charging and discharging circuit of the present disclosure can provide uninterrupted power in different scenarios to meet multi-purpose needs. Furthermore, by sharing a DC bus, the power conversion module can perform the AC/DC conversion and the DC/AC conversion, simultaneously. Since the DC/DC conversion is omitted, the conversion efficiency is enhanced. In other words, the charging and discharging circuit of the present disclosure has many advantages such as small volume, low construction cost, reduced power conversion loss and enhanced energy-saving effect. Furthermore, the first common mode inductor and the second common mode inductor are integrated into the EMI module of the charging and discharging circuit. That is, the charging AC common mode inductor and the discharging AC common mode inductor share the same magnetic core. Consequently, the power density is increased, and the construction cost is further reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A charging and discharging circuit, comprising:
a first AC port, a second AC port and a DC charging port, wherein the charging and discharging circuit selectively receives or provides a first AC power through the first AC port, selectively provides a second AC power through the second AC port, or selectively receives or provides a first DC power through the DC charging port;
an electromagnetic interference (EMI) module, wherein a first port of the EMI module is connected with the first AC port, a second port of the EMI module is connected with the second AC port, and a third port of the EMI module comprises a first terminal, a second terminal, a third terminal and a fourth terminal;
a power conversion module connected between the third port of the EMI module and the DC charging port, and comprising a first bridge arm, a second bridge arm, a third bridge arm, a fourth bridge arm and a fifth bridge arm, wherein the first bridge arm comprises two first switches connected in series, the second bridge arm comprises two second switches connected in series, the third bridge arm comprises two third switches connected in series, the fourth bridge arm comprises two fourth switches connected in series, and the fifth bridge arm comprises two fifth switches connected in series, wherein a first node between the two first switches is connected with the first terminal of the third port of the EMI module, a second node between the two second switches is connected with the first terminal of the third port of the EMI module, a third node between the two third switches is selectively connected to the first terminal or the second terminal of the third port of the EMI module according to an operation mode, a fourth node between the two fourth switches is connected with the fourth terminal of the third port of the EMI module, and a fifth node between the two fifth switches is connected with the third terminal of the third port of the EMI module; and
a controller, wherein the controller selectively enables first AC power and/or the first DC power to simultaneously transmit bidirectional energy through the EMI module and the power conversion module by controlling the two first switches in the first bridge arm, the two second switches in the second bridge arm, the two third switches in the third bridge arm, the two fourth switches in the fourth bridge arm and the two fifth switches in the fifth bridge arm.

2. The charging and discharging circuit according to claim 1, wherein the EMI module comprises a first common mode inductor, and the first common mode inductor comprises a first winding, a second winding, a third winding, a fourth winding and a first magnetic core, wherein a first terminal of the first winding is formed as a first terminal of the first port of the EMI module, a first terminal of the second winding is formed as a first terminal of the second port of the EMI module, a first terminal of the third winding is formed as a second terminal of the second port of the EMI module, and a first terminal of the fourth winding is formed as a second terminal of the first port of the EMI module, wherein the first terminal and the second terminal of the first port of the EMI module are connected with the first AC port, the first terminal and the second terminal of the second port of the EMI module are connected with the second AC port, the first winding, the second winding, the third winding and the fourth winding are wound around the first magnetic core, the first winding and the fourth winding are magnetically coupled with each other, and the second winding and the third winding are magnetically coupled with each other.

3. The charging and discharging circuit according to claim 2, wherein the EMI module further comprises a first capacitor, a second capacitor, a third capacitor and a fourth capacitor, wherein the first capacitor is connected between the first terminal of the first winding and the first terminal of the fourth winding, the second capacitor is connected between the first terminal of the second winding and the first terminal of the third winding, the third capacitor is connected between the second terminal of the first winding and the second terminal of the fourth winding, and the fourth capacitor is connected between the second terminal of the second winding and the second terminal of the third winding.

4. The charging and discharging circuit according to claim 2, wherein the EMI module further comprises a second common mode inductor, and the second common mode inductor comprises a fifth winding, a sixth winding, a seventh winding, an eighth winding and a second magnetic core, wherein a first terminal of the fifth winding is connected with a second terminal of the first winding, a second terminal of the fifth winding is formed as the first terminal of the third port of the EMI module, a first terminal of the sixth winding is connected with a second terminal of the second winding, a second terminal of the sixth winding is formed as the second terminal of the third port of the EMI module, a first terminal of the seventh winding is connected with a second terminal of the third winding, a second terminal of the seventh winding is formed as the third terminal of the third port of the EMI module, a first terminal of the eighth winding is connected with a second terminal of the fourth winding, and a second terminal of the eighth winding is formed as the fourth terminal of the third port of the EMI module, wherein the fifth winding, the sixth winding, the seventh winding and the eighth winding are wound around the second magnetic core, the fifth winding and the eighth winding are magnetically coupled with each other, and the sixth winding and the seventh winding are magnetically coupled with each other.

5. The charging and discharging circuit according to claim 4, wherein the EMI module further comprises a fifth capacitor and a sixth capacitor, wherein the fifth capacitor is connected between the second terminal of the fifth winding and the second terminal of the eighth winding, and the sixth capacitor is connected between the second terminal of the sixth winding and the second terminal of the seventh winding.

6. The charging and discharging circuit according to claim 1, wherein the charging and discharging circuit further comprises a DC bus capacitor bridge arm, and the DC bus capacitor bridge arm comprises two conversion capacitors connected in series, wherein a sixth node between the two conversion capacitors is connected with the fourth node through a third mechanical switch.

7. The charging and discharging circuit according to claim 1, wherein the charging and discharging circuit further comprises a DC/DC conversion module, and the DC/DC conversion module is connected between the power conversion module and the DC charging port.

8. The charging and discharging circuit according to claim 1, wherein the charging and discharging circuit further comprises a first mechanical switch and a second mechanical switch, wherein a first terminal of the first mechanical switch is connected with the first terminal of the third port of the EMI module, a first terminal of the second mechanical switch is connected with the second terminal of the third port of the EMI module, and a second terminal of the first mechanical switch, a second terminal of the second mechanical switch and the third node of the third bridge arm are connected with each other.

9. The charging and discharging circuit according to claim 8, wherein when the controller determines that a charging energy of the first AC power at the first AC port is greater than or equal to a discharging energy of the second AC power at the second AC port according to the operation mode, the second mechanical switch is turned on and the first mechanical switch is turned off, and the first AC power from the first AC port is converted into the first DC power by controlling the first bridge arm, the second bridge arm and the fourth bridge arm of the power conversion module and the first DC power is provided to the DC charging port, and the first AC power from the first AC port is converted into the second AC power by controlling the third bridge arm and the fifth bridge arm of the power conversion module and the second AC power is provided to the second AC port.

10. The charging and discharging circuit according to claim 9, wherein the two first switches comprise a first upper switch and a first lower switch, the two second switches comprise a second upper switch and a second lower switch, the two third switches comprise a third upper switch and a third lower switch, the two fourth switches comprise a fourth upper switch and a fourth lower switch, and the two fifth switches comprise a fifth upper switch and a fifth lower switch, wherein a first driving signal provided to the first upper switch, the second upper switch and the third upper switch and a second driving signal provided to the first lower switch, the second lower switch and the third lower switch are complementary, wherein a third driving signal provided to the fourth upper switch and the fifth upper switch and a fourth driving signal provided to the fourth lower switch and the fifth lower switch are complementary.

11. The charging and discharging circuit according to claim 8, wherein when the controller determines that a charging energy of the first AC power at the first AC port is less than a discharging energy of the second AC power at the second AC port according to the operation mode, the second mechanical switch is turned on and the first mechanical switch is turned off, and the first AC power from the first AC port is converted into a second DC power by controlling the first bridge arm, the second bridge arm and the fourth bridge arm of the power conversion module, and the first DC power from the DC charging port and the second DC power are converted into the second AC power by controlling the third bridge arm and the fifth bridge arm of the power conversion module and the second AC power is provided to the second AC port.

12. The charging and discharging circuit according to claim 11, wherein the two first switches comprise a first upper switch and a first lower switch, the two second switches comprise a second upper switch and a second lower switch, the two third switches comprise a third upper switch and a third lower switch, the two fourth switches comprise a fourth upper switch and a fourth lower switch, and the two fifth switches comprise a fifth upper switch and a fifth lower switch, wherein a first driving signal provided to the first upper switch, the second upper switch and the third upper switch and a second driving signal provided to the first lower switch, the second lower switch and the third lower switch are complementary, wherein a third driving signal provided to the fourth upper switch and the fifth upper switch and a fourth driving signal provided to the fourth lower switch and the fifth lower switch are complementary.

13. The charging and discharging circuit according to claim 8, wherein when the first AC port and the second AC port are in a discharging mode, the second mechanical switch is turned on and the first mechanical switch is turned off, and the first DC power from the DC charging port is converted into the first AC power by controlling the first bridge arm, the second bridge arm and the fourth bridge arm of the power conversion module, and the first AC power is provided to the first AC port, and the first DC power from the DC charging port is converted into the second AC power by controlling the third bridge arm and the fifth bridge arm of the power conversion module, and the second AC power is provided to the second AC port.

14. The charging and discharging circuit according to claim 13, wherein the two first switches comprise a first upper switch and a first lower switch, the two second switches comprise a second upper switch and a second lower switch, the two third switches comprise a third upper switch and a third lower switch, the two fourth switches comprise a fourth upper switch and a fourth lower switch, and the two fifth switches comprise a fifth upper switch and a fifth lower switch, wherein a first driving signal provided to the first upper switch, the second upper switch and the third upper switch and a second driving signal provided to the first lower switch, the second lower switch and the third lower switch are complementary, wherein a third driving signal provided to the fourth upper switch and the fifth upper switch and a fourth driving signal provided to the fourth lower switch and the fifth lower switch are complementary.

15. The charging and discharging circuit according to claim 8, wherein when the first AC port is in a standby state, the second mechanical switch is turned on and the first mechanical switch is turned off according to the operation mode, wherein the first DC power from the DC charging port is converted into the second AC power by controlling the third bridge arm and the fifth bridge arm of the power conversion module, and the second AC power is provided to the second AC port.

16. The charging and discharging circuit according to claim 15, wherein the two first switches, the two second switches and the two fourth switches are turned off, the two third switches comprise a third upper switch and a third lower switch, and the two fifth switches comprise a fifth upper switch and a fifth lower switch, wherein a first driving signal provided to the third upper switch and a second driving signal provided to the third lower switch are complementary, and a third driving signal provided to the fifth upper switch and a fourth driving signal provided to the fifth lower switch are complementary.

17. The charging and discharging circuit according to claim 8, wherein when the first AC port is in a discharging mode, the first mechanical switch is turned on and the second mechanical switch is turned off according to the operation mode, wherein the first DC power from the DC charging port is converted into the first AC power by controlling the first bridge arm, the second bridge arm, the third bridge and the fourth bridge arm of the power conversion module, and the first AC power is provided to the first AC port.

18. The charging and discharging circuit according to claim 17, wherein the two first switches comprise a first upper switch and a first lower switch, the two second switches comprise a second upper switch and a second lower switch, and the two third switches comprise a third upper switch and a third lower switch, and the two fourth switches comprise a fourth upper switch and a fourth lower switch, wherein the two fifth switches are turned off, a first driving signal provided to the first upper switch, the second upper switch and the third upper switch and a second driving signal provided to the first lower switch, the second lower switch and the third lower switch are complementary, and a third driving signal provided to the fourth upper switch and a fourth driving signal provided to the fourth lower switch are complementary.

19. The charging and discharging circuit according to claim 8, wherein when the first AC port is in a charging mode, the first mechanical switch is turned on and the second mechanical switch is turned off according to the operation mode, wherein the first AC power from the first AC port is converted into the first DC power by controlling the first bridge arm, the second bridge arm, the third bridge and the fourth bridge arm of the power conversion module, and the first DC power is provided to the DC charging port.

20. The charging and discharging circuit according to claim 19, wherein the two first switches comprise a first upper switch and a first lower switch, the two second switches comprise a second upper switch and a second lower switch, and the two third switches comprise a third upper switch and a third lower switch, and the two fourth switches comprise a fourth upper switch and a fourth lower switch, wherein the two fifth switches are turned off, a first driving signal provided to the first upper switch, the second upper switch and the third upper switch and a second driving signal provided to the first lower switch, the second lower switch and the third lower switch are complementary, and a third driving signal provided to the fourth upper switch and a fourth driving signal provided to the fourth lower switch are complementary.

21. The charging and discharging circuit according to claim 8, wherein the power conversion module further comprises a first inductor, a second inductor and a third inductor, wherein the first node is connected with the first terminal of the third port of the EMI module through the first inductor, the second node is connected with the first terminal of the third port of the EMI module through the second inductor, and the third node is connected with the first terminal of the third port of the EMI module through the third inductor and the first mechanical switch, and the third node is connected with the second terminal of the third port of the EMI module through the third inductor and the second mechanical switch.

22. A charging and discharging circuit, comprising:
a first AC port, a second AC port and a DC charging port, wherein the charging and discharging circuit selectively receives or provides a first AC power through the first AC port, selectively provides a second AC power through the second AC port, or selectively receives or provides a first DC power through the DC charging port;
an electromagnetic interference (EMI) module comprising a first common mode inductor, wherein the first common mode inductor comprises a first winding, a second winding, a third winding, a fourth winding and a first magnetic core, and the first winding, the second winding, the third winding and the fourth winding are wound around the first magnetic core, wherein the first winding and the fourth winding are magnetically coupled with each other, the second winding and the third winding are magnetically coupled with each other, a first terminal of the first winding and a first terminal of the fourth winding are connected with the first AC port, and a first terminal of the second winding and a first terminal of the third winding are connected with the second AC port;
a power conversion module connected between the EMI module and the DC charging port; and
a controller, wherein the controller selectively enables first AC power and/or the first DC power to simultaneously transmit bidirectional energy through the EMI module and the power conversion module by controlling operations of switches in the power conversion module.

23. The charging and discharging circuit according to claim 22, wherein the EMI module further comprises a first capacitor, a second capacitor, a third capacitor and a fourth capacitor, wherein the first capacitor is connected between the first terminal of the first winding and the first terminal of the fourth winding, the second capacitor is connected between the first terminal of the second winding and the first terminal of the third winding, the third capacitor is connected between a second terminal of the first winding and a second terminal of the fourth winding, and the fourth capacitor is connected between a second terminal of the second winding and a second terminal of the third winding.

24. The charging and discharging circuit according to claim 22, wherein the power conversion module comprises a first bridge arm, a second bridge arm, a third bridge arm, a fourth bridge arm and a fifth bridge arm, wherein the first bridge arm comprises two first switches connected in series, the second bridge arm comprises two second switches connected in series, the third bridge arm comprises two third switches connected in series, the fourth bridge arm comprises two fourth switches connected in series, and the fifth bridge arm comprises two fifth switches connected in series, wherein a first node between the two first switches is connected with a second terminal of the first winding through a first inductor, a second node between the two second switches is connected with a second terminal of the first winding through a second inductor, a third node between the two third switches is selectively connected with a second terminal of the second winding or the second terminal of the first winding according to an operation mode, a fourth node between the two fourth switches is connected with a second terminal of the fourth winding, and a fifth node between the two fifth switches is connected with a second terminal of the third winding.

25. The charging and discharging circuit according to claim 24, wherein the EMI module further comprises a second common mode inductor, and the second common mode inductor comprises a fifth winding, a sixth winding, a seventh winding, an eighth winding and a second magnetic core, wherein a first terminal of the fifth winding is connected with the second terminal of the first winding, a second terminal of the fifth winding is connected with the first node through the first inductor and connected with the second node through the second inductor, a first terminal of the sixth winding is connected with the second terminal of the second winding, a second terminal of the sixth winding is connected with the third node through the third inductor, a first terminal of the seventh winding is connected with the second terminal of the third winding, a second terminal of the seventh winding is connected with the fifth node, a first terminal of the eighth winding is connected with the second terminal of the fourth winding, and a second terminal of the eighth winding is connected with the fourth node, wherein the fifth winding, the sixth winding, the seventh winding and the eighth winding are wound around the second magnetic core, the fifth winding and the eighth winding are magnetically coupled with each other, and the sixth winding and the seventh winding are magnetically coupled with each other.

26. The charging and discharging circuit according to claim 25, wherein the EMI module further comprises a fifth capacitor and a sixth capacitor, wherein the fifth capacitor is connected between the second terminal of the fifth winding and the second terminal of the eighth winding, and the sixth capacitor is connected between the second terminal of the sixth winding and the second terminal of the seventh winding.

27. The charging and discharging circuit according to claim 25, wherein the charging and discharging circuit further comprises a first mechanical switch and a second mechanical switch, wherein a first terminal of the first mechanical switch is connected with a second terminal of the fifth winding, a first terminal of the second mechanical switch is connected with the second terminal of the sixth winding, and a second terminal of the first mechanical switch, a second terminal of the second mechanical switch and the third node of the third bridge arm are connected with each other.

28. The charging and discharging circuit according to claim 27, wherein when the controller determines that a charging energy of the first AC power at the first AC port is greater than or equal to a discharging energy of the second AC power at the second AC port according to the operation mode, the second mechanical switch is turned on and the first mechanical switch is turned off, wherein the first AC power from the first AC port is converted into the first DC power by controlling the first bridge arm, the second bridge arm and the fourth bridge arm of the power conversion module, and the first DC power is provided to the DC charging port, and the first AC power from the first AC port is converted into the second AC power by controlling the third bridge arm and the fifth bridge arm of the power conversion module, and the second AC power is provided to the second AC port.

29. The charging and discharging circuit according to claim 27, wherein when the controller determines that a charging energy of the first AC power at the first AC port is less than a discharging energy of the second AC power at the second AC port according to the operation mode, the second mechanical switch is turned on and the first mechanical switch is turned off, wherein the first AC power from the first AC port is converted into a second DC power by controlling the first bridge arm, the second bridge arm and the fourth bridge arm of the power conversion module, and the first DC power from the DC charging port and the second DC power are converted into the second AC power by controlling the third bridge arm and the fifth bridge arm of the power conversion module, and the second AC power is provided to the second AC port.

30. The charging and discharging circuit according to claim 22, wherein the charging and discharging circuit further comprises a DC/DC conversion module, and the DC/DC conversion module is connected between the power conversion module and the DC charging port.
